(19) United States
(12) Patent Application Publication
(10) Pub. No.: US 2024/0386588 A1
(43) Pub. Date: Nov. 21, 2024

(54) DEVICE AND METHOD OF DETECTING A REGION OF INTEREST IN AN IMAGE

(71) Applicant: Orange, Issy-les-Moulineaux (FR)

(72) Inventors: Olivier HOTEL, CHATILLON CEDEX (FR); Franck ROUDET, CHATILLON CEDEX (FR); David EXCOFFIER, CHATILLON CEDEX (FR)

(21) Appl. No.: 18/664,972

(22) Filed: May 15, 2024

(30) Foreign Application Priority Data
May 16, 2023 (FR) 2304863

(51) Int. Cl. G06T 7/50

(52) U.S. Cl. CPC G06T 7/50; G06T 2207/20104

(57) ABSTRACT

A method of detecting a region of interest in an image is described. The method includes obtaining at least one distribution of the pixels, according to the depth thereof, in a first area of an image. The method also includes detecting at least one region of interest in the first area of the image taking into account, for at least a first peak in the distribution of pixels, a relative height of the first peak in relation to the highest minimum in said distribution of pixels among at least one local minimum lying between said first peak and another peak in the distribution higher than the first peak.

### TECHNICAL FIELD

The disclosed technology relates to a method and system for determining a region of interest in an image, and finds advantage in numerous spheres.

### DISCUSSION OF RELATED TECHNOLOGY

Several methods exist for detecting and isolating regions of interest in images. A region of interest (ROI) can typically be part of an image having noteworthy properties. In particular, it can be an object in an image such as an object in which a user is interested, or an object likely to be of interest to a user, or it can be the subject of subsequent automated processing (e.g. for tracking). It can be useful for example in automated driving systems for detecting vehicles, road signs, persons on the travel path. In logistics systems, it is important to be able to locate objects in warehouses, such objects possibly being of different type. Interactive techniques are available whereby users themselves select the region of interest in more or less accurate or precise manner. There are also several methods based on image processing technologies. With the development of artificial intelligence and more specifically «deep learning» technologies, these techniques for detecting a region of interest have been improved. However, it can sometimes happen that a region of interest thus identified does not fully correspond to an object and does not define the exact contours thereof. Various techniques have been developed to fine-tune the detection of a region of interest that has been roughly identified by a user, or by a first partly automated image processing method. For example, techniques exist which use depth maps and perform background modelling via Gaussian mixture models to identify the foreground of a region of interest. These approaches use advanced data structures (mixture of Gaussian functions and graphs) and in particular consume much computing time. They can only be used therefore on some very large capacity computing architectures. There is therefore a need for simpler solutions that can be applied to fine-tune the determining of a region of interest.

### SUMMARY

The disclosed technology proposes remedying at least one disadvantage of other approaches by proposing a method comprising:
obtaining at least one distribution of the pixels, according to the depth thereof, in a first area of an image;
detecting at least one region of interest in said first area by taking into account, for at least a first peak in said distribution of pixels, a relative height of said first peak in relation to the highest minimum in said distribution of pixels among at least one local minimum lying between said first peak and another peak of said distribution higher than said first peak.

For simplification, in the present application the «relative height» of a peak is the relative height of this peak in relation to this highest local minimum.

Therefore the disclosed technology innovates by proposing to apply a notion similar to the notion of topographic prominence recently introduced in the field of geography, to the detection of regions of interest in a digital image.

In at least one embodiment, the method comprises:
identifying said first area in the image;
obtaining a depth map of said first area in the image.

In at least one embodiment, said detection takes into account the depth of said first peak.

In at least one embodiment, the detection of at least one region of interest comprises:
determining the relative height of peaks of said distribution;
sorting said peaks in decreasing order of their relative height to obtain a second distribution of pixels;
selecting said first peak for which the following peak of relative height has greater depth.

In at least one embodiment, the detection of at least one region of interest comprises:
determining the relative height of peaks in said distribution;
sorting said peaks in increasing order of their depth;
selecting said first peak for which the following depth-ordered peak has a lower relative height.

In at least one embodiment, said region of interest is determined by selecting the set of pixels lying between two minima flanking said first peak selected in said second distribution of pixels.

In at least one embodiment, said distribution is a discrete or continuous distribution.

The characteristics given alone in the present application in connection with some embodiments of the method of the present application can be combined together in other embodiments of the present method.

The disclosed technology also concerns a recording medium readable by a computer on which there is recorded a computer programme comprising instructions to execute the steps of a method comprising:
obtaining at least one distribution of the pixels, according to the depth thereof, in a first area of an image;
detecting at least one region of interest in said first area taking into account, for at least a first peak of said distribution of pixels, a relative height of said first peak in relation to the highest minimum in said distribution of pixels among at least one local minimum lying between said first peak and another peak in said distribution higher than said first peak.

The disclosed technology also concerns a device comprising one or more processors configured together or separately to execute the steps of the method of the disclosed technology, according to any of the embodiments thereof. Therefore, the disclosed technology concerns a device comprising one or more processors configured together or separately to:
obtain at least one distribution of the pixels, according to the depth thereof, in a first area of an image;
detect at least one region of interest in said first area taking into account, for at least a first peak of said distribution of pixels, a relative height of said first peak in relation to the highest minimum in said distribution of pixels among at least one local minimum lying between said first peak and another peak in said distribution higher than said first peak.

### BRIEF DESCRIPTION OF THE DRAWINGS

Other characteristics and advantages of the disclosed technology will become apparent from the description given below, with reference to the appended drawings illustrating an example of embodiment which does not in any respect limit the disclosed technology.

FIG. 1 illustrates a system implementing some embodiments of the disclosed technology.

FIG. 2 gives a representation of an area encompassing a region of interest in an image.

FIG. 3 gives an example of a depth map of the bounding area in FIG. 2.

FIG. 4 illustrates one embodiment of a method of the disclosed technology.

FIG. 5 illustrates a first embodiment of a discrete distribution of pixels according to the disclosed technology.

FIG. 6 illustrates a second embodiment of a continuous distribution of pixels according to the disclosed technology.

FIG. 7 illustrates the notion of peak relative height such as defined in the present application.

FIG. 8 illustrates an embodiment of the sorting of peaks in decreasing order of relative height.

FIG. 9 illustrates an embodiment of the sorting of peaks in increasing order of depth.

### DETAILED DESCRIPTION

The present disclosure concerns the detection of a region of interest in an image. In this document, by region of interest it is meant any part of an image of interest or advantageous for a given application. For example, in one application relating to the automated driving of vehicles, a region of interest can be an obstacle such as another vehicle, an object on the roadway, roadworks, pedestrians . . . ).

In some embodiments, a region of interest may correspond to an object of interest to a user, in different applications.

In some embodiments, the present disclosure relates to the general field of computer vision and useful for various applications employing regions of interest.

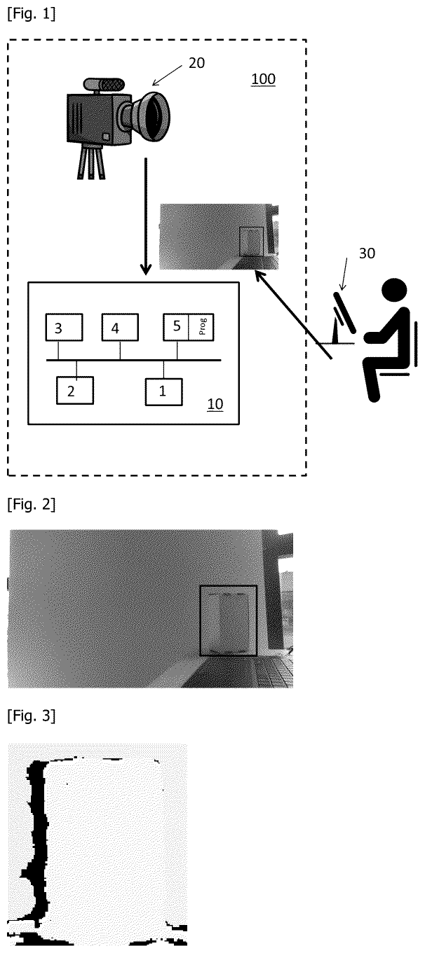

FIG. 1 illustrates a system able to implement some embodiments of the present disclosure.

A scene is captured by capture means 20 capturing at least one image. A scene can represent an indoor or outdoor environment and may comprise one or more objects, animals, persons, backgrounds . . . These capture means can be of several forms according to embodiments and can particularly comprise:
one or more cameras such as stereo cameras and/or LIDAR (LIght Detection And Ranging»), and/or RADAR cameras (RAdio Detection And Ranging»), and/or light field cameras, and/or sensors using ultrasound such as ToF sensors (Time of Flight).

These capture means (20) of at least one image can be associated with processing means 10. The processing means 10 and capture means 20 can be included in one same single device 100 or they can belong to different devices coupled together. The processing means particularly comprise means allowing a depth map to be obtained of at least one portion of the scene in the image captured by the capture means. The processing means in this respect may comprise stereo vision, Radar vision, Lidar vision devices, and/or devices of ToF type.

As illustrated in FIG. 1, the processing means may have the material architecture of a computer. Therefore, the processing means 10 particularly comprise a processor 1, a RAM memory 2, ROM memory 3 and non-volatile memory 4. They also comprise communication means 5, in particular to communicate with the capture device 20 and a user interface 30.

The ROM memory 3 forms a recording medium conforming to at least one embodiment of the present disclosure, readable by the processor 1 and on which a computer programme PROG is recorded conforming to at least one embodiment of the present disclosure, comprising instructions to execute steps of the method to determine a region of interest according to at least one embodiment of the present disclosure. The PROG programme defines functional modules of the device.

The user interface 30 can enable a user to interact with the capture and processing means. The user interface can be in several forms, in particular one or more screens, whether or not touch screens, one or more keyboards or stylus pens or tablet, a mobile telephone or computer. In FIG. 1, the user has selected an area encompassing the region of interest.

FIG. 2 illustrates an example of a scene filmed by the image capture means 20 (a camera in this example) and in which an area is delimited by a black rectangle. This area is intended to encompass a region of interest (e.g. an object) of which the position within this area is precisely to be determined by the present disclosure. Hereafter, this area can also be called a bounding area.

In some embodiments, the area is delimited by a user by means of a user interface 30.

In some embodiments, the area is delimited automatically by the processing means 10. This delimiting for example can use methods based on artificial intelligence.

In some embodiments, the area is delimited both manually and automatically. For example, a user can indicate to the processing means that it is desired to determine the area(s) comprising a certain type of object e.g. a vehicle, and the processing means are then tasked with the operation of detecting vehicles in the image and delimiting the areas containing vehicles present in the image.

In some embodiments, several bounding areas can be identified automatically by the processing means, or manually by a user.

FIG. 3 gives an example of a depth map of the bounding area illustrated in FIG. 1. In some embodiments, the depth map can be obtained per bounding area, for all or some bounding areas, or for all or part of the captured image.

A depth map can be a representation of the image in shades of grey, where the grey shade indicates the distance to the camera: the darker the area the closer it is to the camera, or conversely. A depth map gives a view of a matrix (a picture in two dimensions for example) which, with each pixel, associates the distance (in metres or any other unit of distance) at which it lies from the camera.

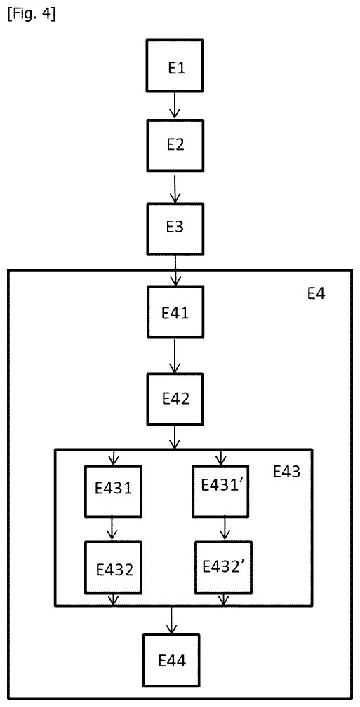

FIG. 4 illustrates one embodiment of a method according to the present disclosure.

The method, according to at least one embodiment of the present disclosure, can be implemented on a device such as the device 100 illustrated in FIG. 1.

One or more images of a scene are captured by the image capture means identified in FIG. 1. With the present method, it is possible to identify one or more regions of interest in this or these images.

For example, at step E1, a first area of the image is identified or selected. For example, a user selects one or more areas in an image encompassing the region(s) of interest approximately or roughly i.e. the bounding area comprises at least one portion of image which does not belong to the region of interest. The bounding area can be an area having contours which approximately follow the contours of the region of interest and/or it can be of geometric shape. For example, if the user selects the area manually (using a stylus pen or mouse for example), the bounding area can be a rectangle around a region of interest (for example when the region of interest is itself of more or less rectangular shape) (as illustrated in FIG. 2), or a circle around a region of interest (e.g. if the region of interest is itself of more or less round shape) . . . This selection can be performed by means of the user interface 30 identified in FIG. 1. This selection can be made by surrounding the region of interest so that the region of interest is encompassed in its entirety. As previously mentioned, this selection can also be made automatically or semi-automatically by the processing means 10, using methods based on artificial intelligence for example. The processing means can be parameterized by learning process to identify certain objects e.g. animals in a scene and to delimit an area encompassing animals for each detected animal.

The bounding area thus approximately delimited, around the region of interest, therefore comprises a set of pixels of which some belong to the region of interest to be isolated or identified.

Once the bounding areas are obtained, a depth map is obtained for each or some of the bounding areas, step E2.

In some embodiments, a global depth map of the captured image can be constructed and this map can be segmented into several depth maps each representing a portion of the captured image, at least one of the depth maps representing a portion of the captured image and comprising at least one bounding area surrounding at least one region of interest able to be used in the remainder of the method described below.

In some embodiments, when several bounding areas are identified, at least some of the steps of the method below can be performed simultaneously or in parallel for different identified bounding areas.

As previously mentioned, the depth maps can be obtained for example by the processing means 10 or by devices coupled to these processing means, by stereo vision Radar vision, Lidar vision devices, or devices of (ToF) type (time of flight).

At the following steps, the method allows the determining of at least one region of interest in at least one bounding area from at least one depth map associated with this bounding area.

To do so, at step E3 from the depth map obtained for the bounding area, a distribution or representation of the distribution is obtained of the pixels in the bounding area, according to their depth.

The distribution obtained can be of different types. In at least one embodiment, the distribution is a discrete distribution (e.g. in the form of a histogram). In at least one embodiment, the distribution is a continuous distribution

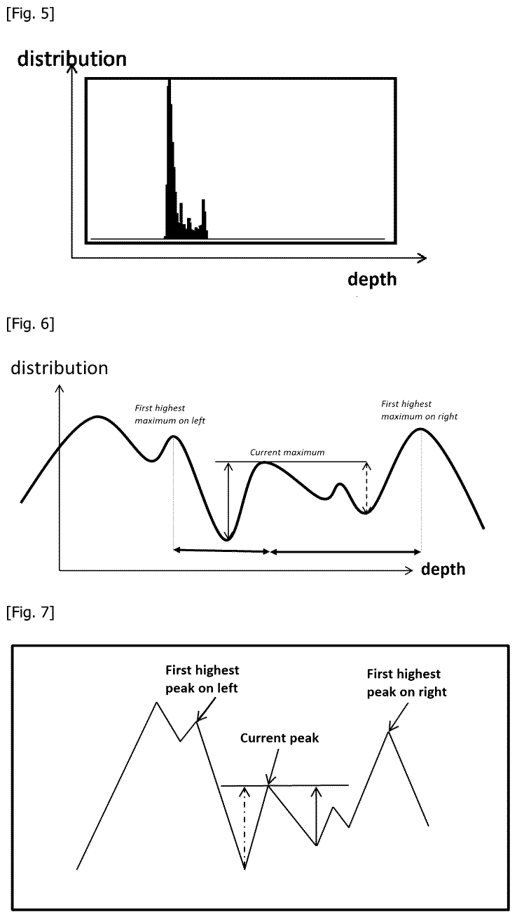

As an example, FIG. 5 illustrates a representation in the form of a histogram.

In this histogram, the X-axis represents the distance to the camera (hence depth) and the Y-axis represents the number of pixels. The chosen pitch or granularity on the X-axis is 5 cm. The height of the histogram columns represents the number of pixels in each interval, the intervals on the X-axis possibly being [0, 5 cm]; [5, 10 cm]; [10, 15 cm] . . . This granularity can evidently vary and can depend for example on the maximum depth, the greater the maximum depth the greater the granularity. It can also depend on, or be indexed on, the size of the area.

FIG. 6 illustrates a continuous representation. The X-axis represents the distance to the camera, hence the depth, and the Y-axis represents the number of pixels.

At step E4, at least one region of interest is determined in at least one of the previously selected bounding areas. This determination, for at least a first peak of the distribution of pixels, takes into account a relative height of the first peak in relation to at least one second peak in the distribution of pixels, the second peak being the highest local minimum in the distribution of pixels between the first peak and another peak in the distribution higher than said first peak.

In some embodiments, the determination takes into account the depth of the first peak. Therefore, it can be possible to select a peak in the foreground for example, or a peak close to this foreground.

In some embodiments, E4 may comprise the obtaining (locating or identification), E41, of peaks in the representation. The peaks of the histogram are identified in FIG. 5, the index i representing an interval number on the X-axis; a peak Pi is such that its height H verifies:

$${H}_{i - 1} < {H}_{i} > {H}_{i + 1}$$

In some embodiments, step E4 may comprise the obtaining (or determining), E42, of information or data relating to the height, also called relative height for simplification, of the peaks in the representation.

FIG. 7 illustrates the distribution of the relative heights of the peaks (such as determined at step E42) in the distribution of pixels.

In the illustrated example, the relative height of a peak is the minimum difference between the height of the peak and the histogram minimum between this peak and the peaks immediately above on the right and left of the latter, if any. The relative height of the highest peak corresponds to the height thereof.

In FIG. 7, the relative height of a peak Pᵢ is calculated as follows:
the highest peak on the right and the highest peak on the left of the current peak Pᵢ are determined;
the minima MinGᵢ and MinDᵢ are determined on each of the intervals, defined by:
MinGᵢ: minima between the current peak and the highest peak on the left, and
MinDᵢ: minima between the current peak and the highest peak on the right,
MinDᵢ has a height HDᵢ and MinGᵢ has a height HGᵢ.
the relative height PRO (Pᵢ) of the current peak Pᵢ is given by:

$$PRO ( {P}_{i} ) = Min ( ( {H}_{i} - {HD}_{i} ) ; ( {H}_{i} - {HG}_{i} ) ) \qquad [ MATH . 2 ]$$

The definition given above of the relative height of a peak also applies to a

continuous distribution, but the identification of the peaks may differ. For this purpose, the calculation of the relative height of a peak, for a continuous representation, may entail identifying the extremes of the distribution.

The maximum of a mathematical function verifies f′(x)=0 and f″<0; whilst the minimum of a function f verifies f′(x)=0 and f″>0; f′ and f″ respectively representing the first and second derivatives of function f.

The minima and maxima can be identified by solving the equation f′(x)=0

This equation can be solved:
analytically by directly solving the equation, or
digitally using Newton's method.

Calculation of the second derivative then allows a distinction to be made between the minima and maxima.

The minima and maxima being known, the relative height of a maximum can then be obtained by applying the preceding definition.

The region of interest can be determined by selecting the peak in the foreground or close to the foreground having the highest relative height, step E43. The region of interest can be determined from a representation of the relative height of the peaks in the distribution of pixels. To do so, it is possible to represent the distribution of relative heights (and no longer the height of the peaks in the distribution of pixels as in FIG. 6).

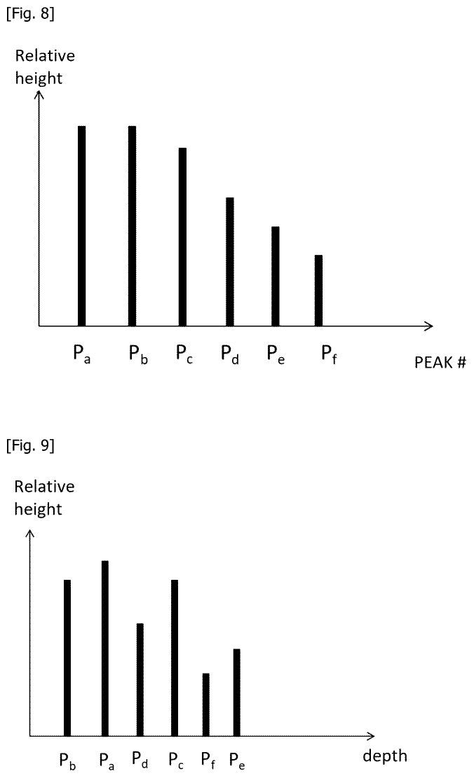

FIGS. 8 and 9 schematically illustrate 6 peaks denoted Pₐ, P_{b}, P_{c}, P_{d}, Pₑ, P_{f} which were previously identified at step E41. If FIG. 5 represents a first distribution or representation of a first distribution, then FIGS. 8 and 9 can represent a second, respectively a third distribution or representation of a second, respectively third distribution.

With each of these peaks Pₐ, P_{b}, P_{c}, P_{d}, Pₑ, P_{f}, there is associated a depth respectively denoted Depth(Pₐ), Depth(P_{b}), Depth(P_{c}), Depth(P_{d}), Depth(Pₑ), Depth(P_{f}).

With each of these peaks Pₐ, P_{b}, P_{c}, P_{d}, Pₑ, P_{f}, there is associated a relative height respectively denoted RH(Pₐ), RH(P_{b}), RH(P_{c}), RH(P_{d}), RH(Pₑ), RH(P_{f}).

In this example, we have:

$$RH ( {P}_{a} ) > RH ( {P}_{b} ) = RH ( {P}_{c} ) > RH ( {P}_{d} ) > RH ( {P}_{e} ) > RH ( {P}_{f} )$$

$$Depth ( {P}_{b} ) < Depth ( {P}_{a} ) < Depth ( {P}_{d} ) < Depth ( {P}_{c} ) < Depth ( {P}_{f} ) < Depth ( {P}_{e} )$$

In a first embodiment of step E43, it is possible to sort the peaks at E431 in decreasing order of their relative height as schematically illustrated in FIG. 8, to facilitate identification of the peak in the foreground or close to this foreground having the highest relative height.

By browsing through the peaks in the direction of decreasing relative height, and for each peak, the depth of the current peak is compared with the depth of the peak following after the current peak, and at step E432 the first peak is selected for which the following peak has greater depth. Therefore, the peak selected in this example is peak P_{b}, since peak Pₐ has a greater relative height but a smaller depth, and the following peaks all have a greater depth. It can be noted that peak P_{c} has the same relative height but a greater depth, and is therefore not selected. Therefore, peak P_{b} here represents the foreground peak.

In a second embodiment of step E43, it is possible to sort the peaks at E431′ in increasing order of their depth as schematically illustrated in FIG. 9, to facilitate identification of the peak in the foreground or close to the foreground having the highest relative height.

By browsing through the peaks in the direction of increasing depth, the relative height of the current peak is compared with the relative height of the peak following after the current peak, and at E432′ the first peak is selected for which the following peak has a lower relative height. Therefore the peak selected in this example is peak Pₐ, since peak P_{b} which has a greater depth has a greater relative height. It can be noted that peak P_{c}, has the same relative height but a greater depth, and is therefore not selected. Therefore peak Pₐ here is a peak that is not in the foreground but is close to the foreground. For example, it is thus possible to filter parasitic elements in the foreground.

It can be noted in this representation in increasing order of depth that, in some embodiments, if two peaks have the same associated depth then, for same depth, the peak having the highest relative height is selected.

The region of interest is determined from the representation obtained, at step E43.

In some embodiments, the region of interest is obtained by selecting, at step E44, a set of pixels around the peak selected at step E43.

In some embodiments, this set of pixels is composed of the pixels lying between the two minima flanking the peak selected at step E43.

Some applications of this disclosure can find advantage in the manufacturing industry, and in particular for checking the conformity of a part produced on a production line. The present disclosure can help towards precise detection of a part and hence determination of the shape, size thereof, to verify whether it conforms to an expected result or to specifications, this operation being at least partly automatic (without human intervention for example). Knowledge of the size and location of objects can also contribute toward stabilizing and precisely defining movements of robots handling these objects.

Other applications can concern the logistics sector. Some embodiments in the present disclosure can be used to track and locate goods in warehouses. Knowledge of the size of objects can help toward estimating (e.g. optimizing) the storage space required for storing goods, and can therefore form part of warehousing flow management.

Other applications can concern the automated driving of vehicles by allowing determination of obstacles on the roadway for example, a region of interest possibly representing an obstacle (other vehicles, objects, roadworks, pedestrians . . . ).

Other applications can concern the mapping of a physical environment, to allow the navigation of robots, drones and automated vehicles in the presence of obstacles.

1) A method comprising:
obtaining at least one distribution of pixels, according to depth of the pixels, in a first area of an image; and
detecting at least one region of interest in said first area of the image taking into account, for at least a first peak in said distribution of pixels, a relative height of said first peak in relation to a highest minimum in said distribution of pixels among at least one local minimum lying between said first peak and another peak in said distribution higher than said first peak.

2) The method of claim 1, further comprising:
identifying said first area of the image; and
obtaining a depth map of said first area of the image.

3) The method of claim 1, wherein said detecting of at least one region of interest takes into account a depth of said first peak.

4) The method of claim 1, wherein said detecting of at least one region of interest comprises:
determining relative heights of said peaks in said distribution;
sorting said peaks in decreasing order of their relative height to obtain a second distribution of pixels; and
selecting, as said first peak, a peak for which the following peak of relative height has greater depth.

5) The method of claim 1, wherein said detecting of at least one region of interest comprises:
determining a relative height of said peaks in said distribution;
sorting said peaks in increasing order of their depth; and
selecting, as said first peak, a peak for which the following depth-ordered peak has a lower relative height.

6) The method of claim 4, wherein said at least one region of interest is detected by selecting a set of pixels lying between two minima flanking said first peak selected in said second distribution of pixels.

7) The method of claim 1, wherein said distribution is a discrete or continuous distribution.

8) A recording medium readable by a computer on which there is recorded a computer program comprising instructions to execute the steps of a method comprising:
obtaining at least one distribution of pixels, according to depth of the pixels, in a first area of an image; and
detecting at least one region of interest in said first area of the image taking into account, for at least a first peak in said distribution of pixels, a relative height of said first peak in relation to a highest minimum in said distribution of pixels among at least one local minimum lying between said first peak and another peak in said distribution higher than said first peak.

9) A device comprising one or more processors configured together or separately to:
obtain at least one distribution of pixels, according to depth of the pixels, in a first area of an image; and
detect at least one region of interest in said first area of the image taking into account, for at least a first peak in said distribution of pixels, a relative height of said first peak in relation to a highest minimum in said distribution of pixels among at least one local minimum lying between said first peak and another peak in said distribution higher than said first peak.
